(19) United States
(12) Patent Application Publication
(10) Pub. No.: US 2014/0358611 A1
(43) Pub. Date: Dec. 4, 2014

(54) ORGANIZATIONAL TASK MANAGEMENT SOFTWARE SYSTEM

(71) Applicants: ALOK DATTA, PUNE (IN); AKSHAY SHAH, PUNE (IN)

(72) Inventors: ALOK DATTA, PUNE (IN); AKSHAY SHAH, PUNE (IN)

(21) Appl. No.: 13/974,425

(22) Filed: Aug. 23, 2013

(30) Foreign Application Priority Data
May 31, 2013 (IN) 1911/MUM/2013

(51) Int. Cl. G06Q 10/06

(52) U.S. Cl. CPC G06Q 10/063114
USPC 705/7.15; 705/7.12

(57) ABSTRACT

Web-based business process management software systems built on client-server architecture are described. The application and database may reside on central servers and may be accessed via dedicated links or the Internet across multiple locations simultaneously. Each person may have a predefined role and, based on that, the system may authenticate and authorize a person to access only the screens and data to which the user has been provided access. The user may only record the completion status and not modify the task in any way. This control may be restricted to only authorized personnel. When users log in, they may be presented with easy to use menus of routines and tasks organized by customer, people, processes and financial categories. In each of these categories, the user may be presented with their tasks for the day/week/month in a visually appealing way to record the completion status of the task.

### CROSS-REFERENCE TO RELATED APPLICATION

The instant application claims priority to Indian Patent Application Serial No. 1911/MUM/2013, filed May 31, 2013, pending, the entire specification of which is expressly incorporated herein by reference.

### FIELD OF INVENTION

This invention relates generally to the field of information technology and business process management, and more specifically to web-based business process management software systems based on client server architecture, that are built on a balance scorecard framework.

### BACKGROUND OF THE INVENTION

Project management systems have been used to help management teams to plan and manage tasks and were typically designed to help the project manager control a particular project or series of sub-projects by top-down control directives. Although this worked well for the project manager, these systems generally lacked critical features such as monitoring, focus on operational issues, exception handling, and escalation management. Furthermore, these systems were usually focused on project completion and lacked the tactical and strategic vision that was essential for a holistic solution.

Conventional task management software, such as organizers, list managers and schedulers, are good for tracking tasks, activities and their status. However, they provide little assistance in planning, and their resource management capacity is minimal Furthermore, planning methods are not linked to key result areas (KRA), key performance indicators (KPI) and do not complement the tasks of various managers.

Another area of concern is governance, risk management and compliance (GRC). Conventional GRC products typically work on analyzing data from the enterprise systems (e.g., focus is more on the financial and customer data) and come up with insights to manage risk and compliance. However, conventional GRC systems do not engage with business in real time at a ground level through a proven balance scorecard (BSC) framework with tasks and routines that covers day to day operations.

Accordingly, there exists a need for new and improved systems that overcome at least one of the aforementioned disadvantages.

### SUMMARY OF THE INVENTION

The present invention aims to provide an alternative to above conventional products and systems of task and project management. The cornerstone of this system is the background workflow that intelligently manages the escalations and exceptions and ensures that the right information reaches the right person in time. Beyond that, if the expected layer does not act on it, there is an auto mechanism provided to escalate the same further to ensure that the exception gets managed before it becomes a major issue.

The present invention provides a comprehensive, balanced mix with equal attention to people, processes, customers and financials, unlike conventional systems that are often only based around financial targets and actions and processes that are critical to its competitiveness in the market place. The cornerstone of the present invention is the holistic strategy of developing the routines and the tasks that are taken by leveraging the organizational experience, processes, resources and knowledge, taking into account organizational strategy and vision. Other conventional systems rely on packaged tasks, and as a result, the adoption of these conventional systems has a low success rate.

An audit mechanism generally complements the adherence and effectiveness strategy post implementation of the present invention. Conventional systems work on assumptions, and generally, there is no provision or attempt to analyze the impact of assumptions and the possible impacts on and across an organization. That is, no analysis is undertaken of any performance data with regard to its effect on other business units within an organization and the effect on a range of specific performance indicators related to adherence and effectiveness within the organization.

Once implemented, the present invention provides that all levels of an organization are interlinked and networked and uses a consistent planning structure based on shared information. The system of the present invention also enables managers to review the performance data of their subordinates (either direct or indirect), i.e., resources reporting to them. Analysis and visibility of this information leads to much more effective management.

Within the field of information technology and business process management, one approach is the BSC methodology. At one level, it considers key responsibility areas, performance indicators and critical success factors of each role within the organization, taking into account the interdependencies within each of the roles. It takes a strategic as well as an operational perspective. The present invention focuses on improvements in systemizing a range of management processes that are undertaken in the normal course of operating a business.

The present invention focuses on systems of organizational planning that includes information and references to the business processes that are applied within an organization. One of the biggest challenges that organizations face is to ensure that its vision and goals are translated into day to day tasks that are carried out by all their employees in a way that leverages the organizational experience and intelligence by creating effective alignment and collaboration between all the layers. These need to be followed by an effective system to ensure that there are systems to assure that all the tasks are followed with clear visibility into the status and the results of these tasks.

The foundation of the system of the present invention is the BSC approach that provides a balanced focus on customers, people, processes and financials, unlike conventional tools where the primary focus remains on the financial metrics. It is the most widely adopted performance management framework. It is now seen as a critical foundation in a strategy execution process that besides helping organizations articulate strategy in actionable terms, provides a road map for strategy execution, for mobilizing and aligning executives and employees and making strategy a continual process.

The present invention provides an easy to use web-based software system built on a BSC framework where the routine and task structure is derived based on existing best practices of the day to day tasks combined with the organizational vision in terms of KRA and KPI of individuals. It brings disparate operations data into information and knowledge, and provides insight and control across the levels that enable the organization to take corrective actions before issues escalate.

When users log into the system of the present invention, they are presented with an easy to use menu of routines and tasks organized by customers, people, processes and financials. In each of these categories, the user is presented with his tasks for the day/week/month in a visually appealing way to record the completion status of the task. The user may be encouraged to attach documents that can validate the completion status. If there are challenges for the task, then they can escalate it to their reporting manager. Behind the scenes, there may be a complex maze of business rules that drive an active workflow. Furthermore, there may be an auto escalation mechanism that would escalate to higher levels based on the elapsed time and severity. The present invention also provides a management information system (MIS) to track adherence and continuously improve effectiveness.

In accordance with one aspect of the present invention, web-based software systems, e.g., built on client-server architecture, are provided. By way of a non-limiting example, the application and database may reside on a central server and may be accessed via dedicated links or the Internet across multiple locations simultaneously. Each person may have a predefined role and, based on that, the system may authenticate and authorize a person to access only the screens and data to which the user has been provided access. For example, the user may only record the completion status and not modify the task in any way. This control may be restricted to only authorized personnel.

The principle objective of invention is to create an improved form of tracking and planning system through the integration of daily tasks, organizational plans and performance measures so as to provide a substantial synergistic effect across supervisory and management layers

Another objective of the invention is measurable improvements in efficiency through technology where there are complex workflows, business rules and business intelligence that drive collaboration, escalations and MIS.

Still another objective is effective collaboration between the different layers in the organization that results from the core feature of the present invention which is the cascading of tasks.

Yet another objective is to link to external enterprise systems through its routines and task with the present invention acting as a central hub.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention will now be described in relation to the accompanying drawings in which:

FIG. 1 illustrates a chart showing illustrative examples of the primary routines of the present invention;

FIG. 2 illustrates a chart showing illustrative examples of how one of the routines is broken down into tasks;

FIG. 3 illustrates a schematic view of an illustrative architecture of the present invention;

FIG. 4 illustrates a screen capture of an illustrative home page or screen of the present invention;

FIG. 5 illustrates a screen capture of an illustrative example of a customer-focused screen of the present invention;

FIG. 6 illustrates a screen capture of an illustrative example of a people-focused screen of the present invention;

FIG. 7 illustrates a screen capture of an illustrative example of a process-focused screen of the present invention;

FIG. 8 illustrates a screen capture of an illustrative example of a financials-focused screen of the present invention;

FIG. 9 illustrates a screen capture of an illustrative example of a reports-focused screen of the present invention;

FIG. 10 illustrates a screen capture of an illustrative example of a reviews-focused screen of the present invention;

FIG. 11 illustrates a screen capture of an illustrative example of an alternative reviews-focused screen of the present invention;

FIG. 12 illustrates a screen capture of an illustrative example of an escalations-focused screen of the present invention; and

FIG. 13 illustrates a screen capture of an illustrative example of a help-focused screen of the present invention;

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

The present invention provides a software product that communicates with the organization, its goals and provides a functional and practical day to day action and task oriented map needed to achieve those goals. The present invention enables management to set priorities, focus energy and resources, strengthen operations, ensure that employees and other stakeholders are working toward common goals, establish agreement around intended outcomes/results, and assess and adjust the organization's direction in response to a changing environment. The present invention automatically allocates to each user his appropriate routines and the tasks based on his role, and tracks the completion status.

The present invention was designed, without limitation, to manage the following challenges: (1) align vision with work done every day; (2) align with BSC methodology; (3) leverage experience and intelligence; (4) manage by exceptions; (5) measure what matters; (6) alignment and collaboration between layers; (7) reduce reporting overheads; (8) provide a clear list of tasks to be done; (9) assurance that all activities are followed; (10) clear visibility into service level agreements (SLA) and status; and (11) identify and correct trends before it becomes an issue.

One of the best ways to implement the present invention in any organization is to go through one or more of the following primary steps: (1) interview the supervisory and the management layer and collate a comprehensive list of tasks that they are currently doing and the ones they should do as a best practice; (2) affinitize the tasks and group them based on role and frequency; (3) review the gaps between the expected critical success factors/KRA and KPI; (4) ensure alignment through a cascade of tasks; (5) create a proposed set of routines and tasks; and/or (6) validate with each layer and their reporting layer and the management layers.

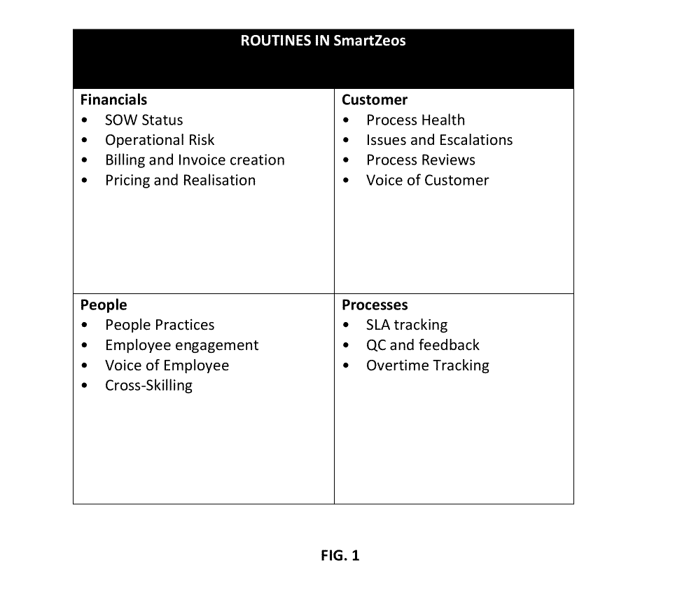

Referring to FIG. 1, there is shown an illustrative example of the primary routines.

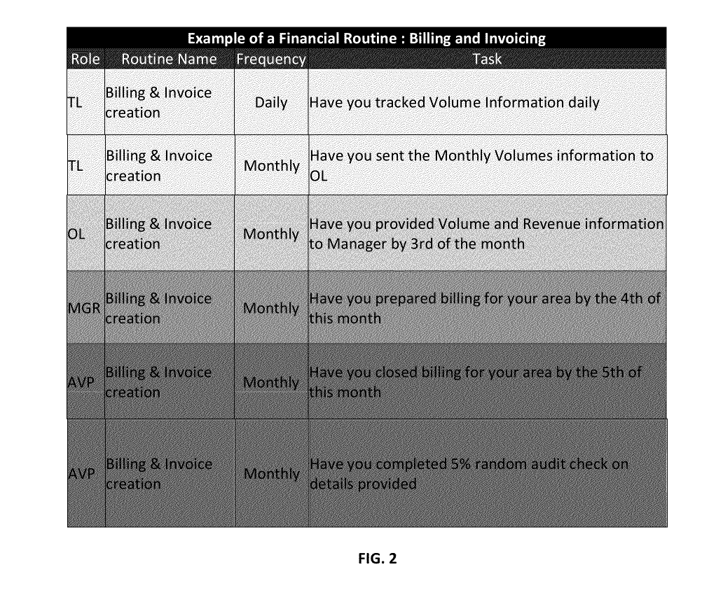

Referring to FIG. 2, there is shown an illustrative example of how a routine may be broken down into tasks.

In accordance with one aspect of the present invention, the present invention may be implemented in the form of a web-based software program, e.g., built on a client-server architecture.

Here, the application (e.g., a software program loaded onto a computer storage system (e.g., a hard drive or any other non-transitory computer readable medium), wherein the computer's processor is selectively operable to access and run the software program) and any associated databases may reside on a central server and this may be accessed via dedicated links or the Internet across multiple locations simultaneously. Each person may have a predefined role, and based on that, the system may authenticate and authorize a person to access only the screens and data to which the user has been provided access. Also, the user may only record the completion status and not modify the task in any way. This control may be restricted to only authorized personnel.

When users log into the present invention (e.g., via an input system (e.g., a keyboard) or graphical user interface (e.g., a mouse) operably associated with a computer system having a processor), they may be presented with easy to use menus of routines and tasks (e.g., via a viewing device such as a computer monitor or screen) organized by customer/people/processes and financials. In each of these categories, the user may be presented with his tasks for the day/week/month in a visually appealing way to record the completion status of the task. The users may be encouraged to attach documents that can validate the completion status. If there are challenges for the task, then they may escalate it to their reporting manager. Behind the scenes may be a complex maze of business rules that may drive an active workflow. Furthermore, there may be an auto escalation mechanism that may escalate to higher management levels based on the elapsed time and severity. The present invention may also provide MIS to track adherence and continuously improve effectiveness.

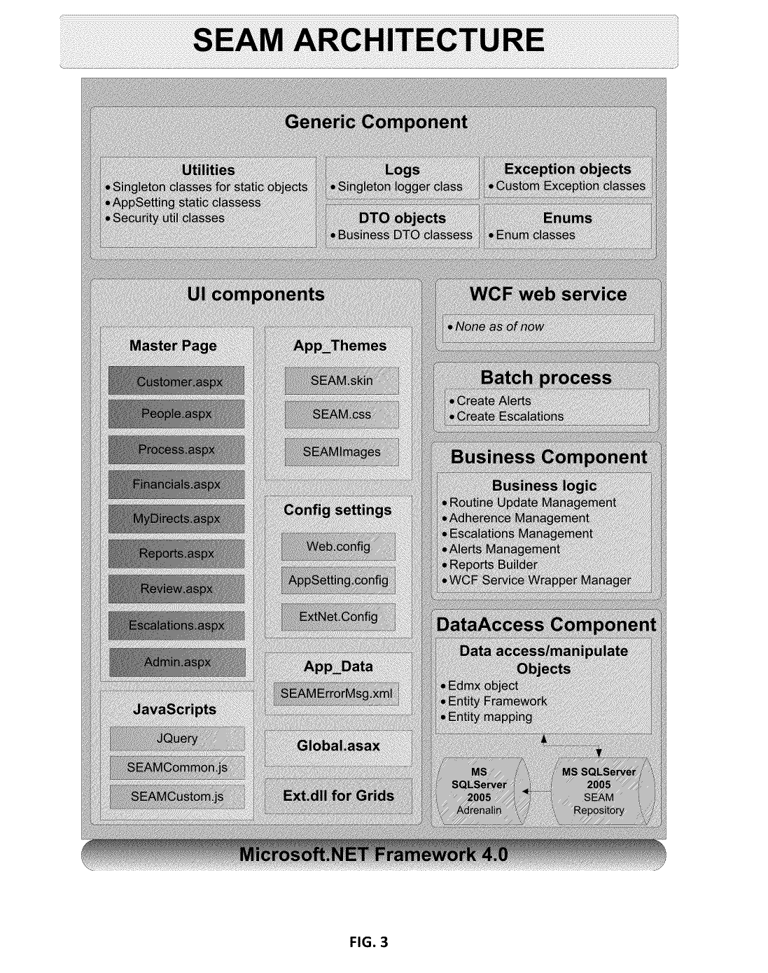

Referring to FIG. 3, there is shown an illustrative example of the architecture of the present invention.

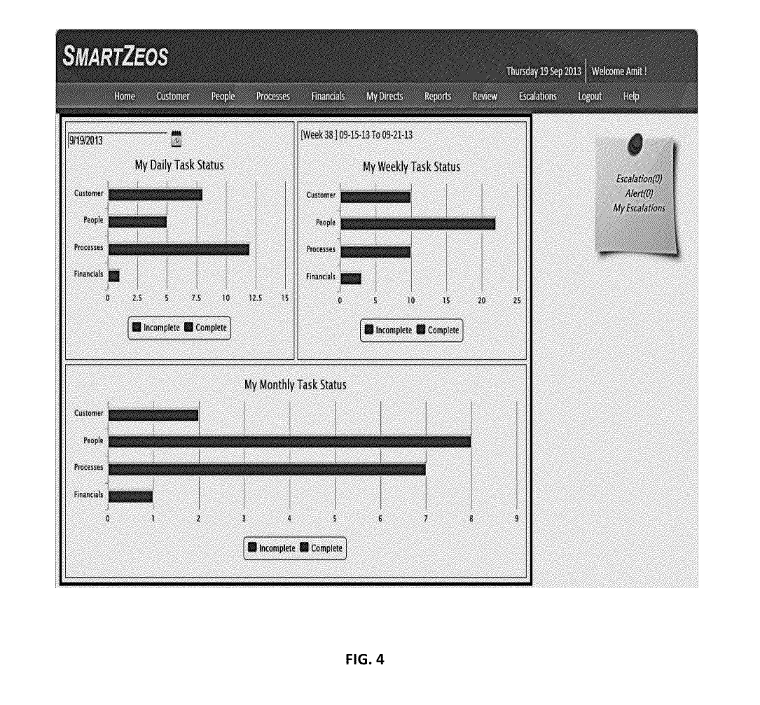

Referring to FIG. 4, there is shown an illustrative example of a home page or screen. After logging in, the user may view his/her daily/weekly/monthly tasks “dashboard” for the customer, people, processes and financials categories in a graphical format. The user may have the option to view daily tasks on a per date basis, weekly on a week basis and monthly on a month basis. The user may view tasks in color coded format, e.g., a complete task in green, and an incomplete task in red.

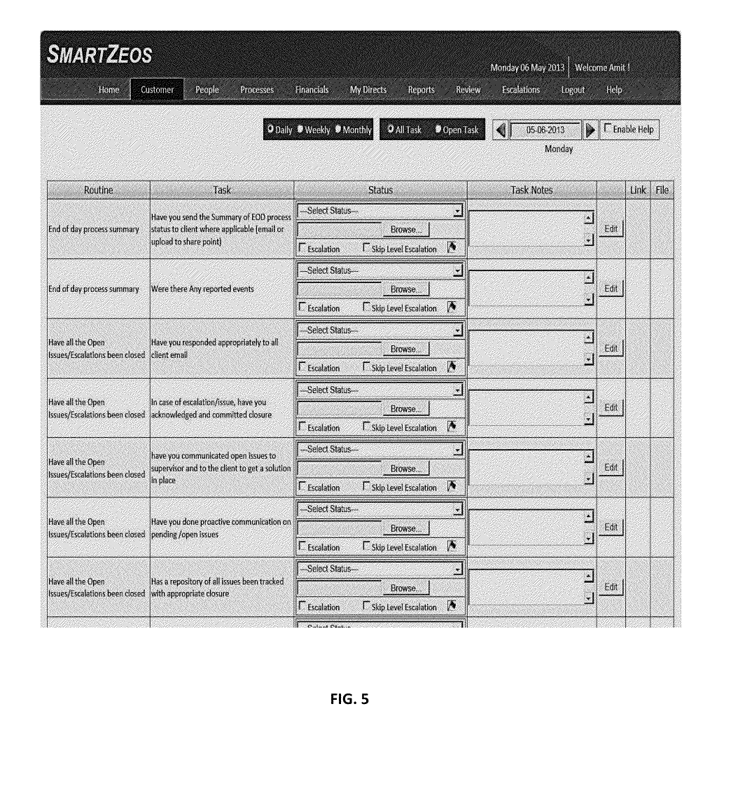

Referring to FIG. 5, there is shown an illustrative example of a customer-focused screen. After logging in, the user may add the status on the customer related daily, weekly and monthly tasks. The user may also check for any open tasks. For all negative tasks, the user may need to provide notes for it. The user may have the option to edit tasks before going for escalation or skip level escalation options. The user may attach a file when he/she is going for escalation or skip level escalation options. In the escalation option, the user may escalate the task to a reporting manager and in the skip level escalation option, the user may have the option to skip the level of manager and escalate to the functional manager (or some other high-ranking management official).

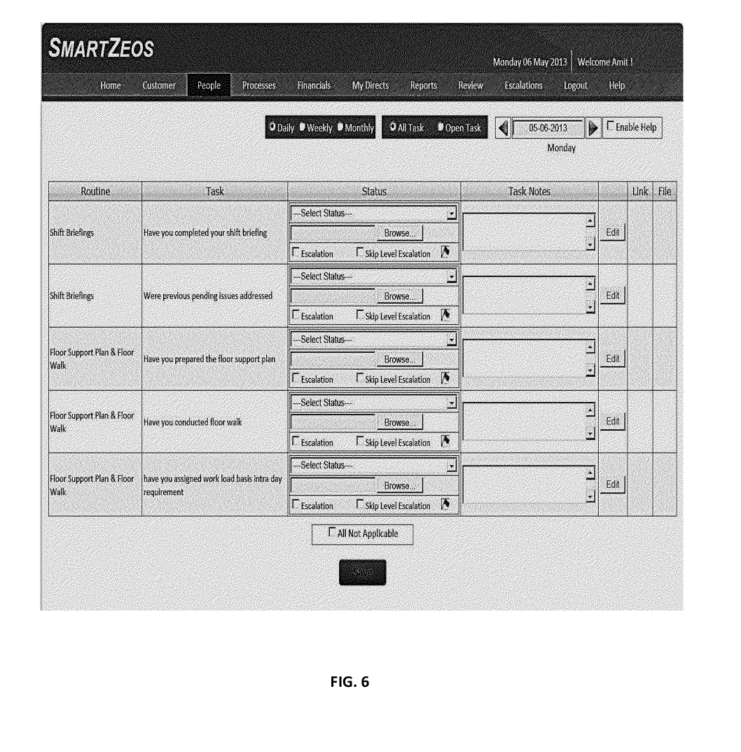

Referring to FIG. 6, there is shown an illustrative example of a people-focused screen. After logging in, the user may add status on the people related daily, weekly and monthly tasks. The user may also check for any open tasks. The user may have a calendar by which he/she can view tasks saved history. The user may have an enable help option which may provide help on the task of his role.

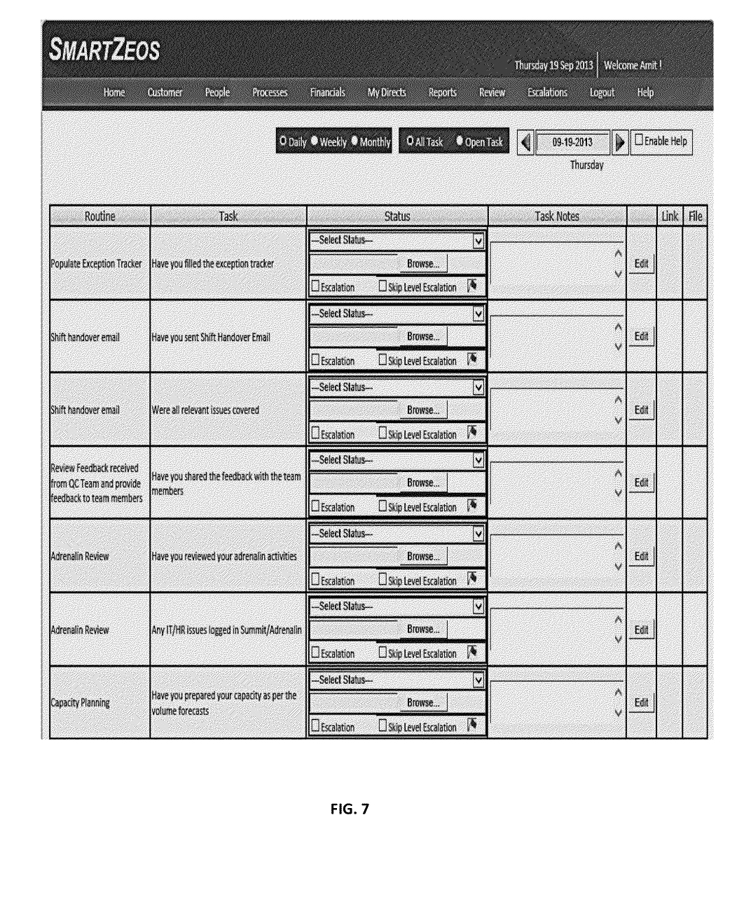

Referring to FIG. 7, there is shown an illustrative example of a process-focused screen. After logging in, the user may add status on the process related daily, weekly and monthly tasks. The user may also check for any open tasks. The user may have the option to select “all not applicable,” if it is applicable on his routines and tasks.

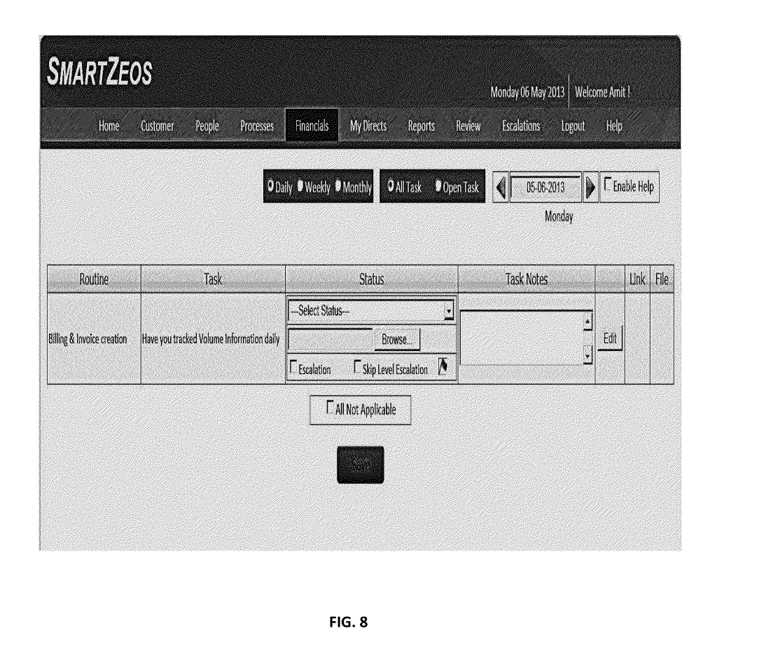

Referring to FIG. 8, there is shown an illustrative example of a financials-focused screen. After logging in, the user may add status on the financials related daily, weekly and monthly tasks. The user may also check for any open tasks.

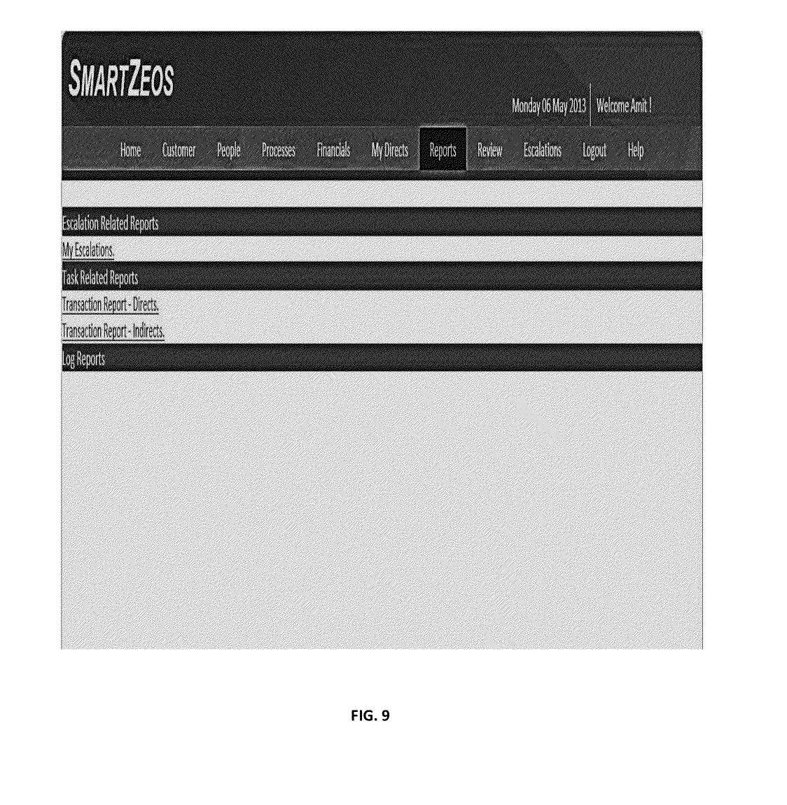

Referring to FIG. 9, there is shown an illustrative example of a reports-focused screen. After logging in, the user may see any escalation related reports, task related reports, and/or log reports.

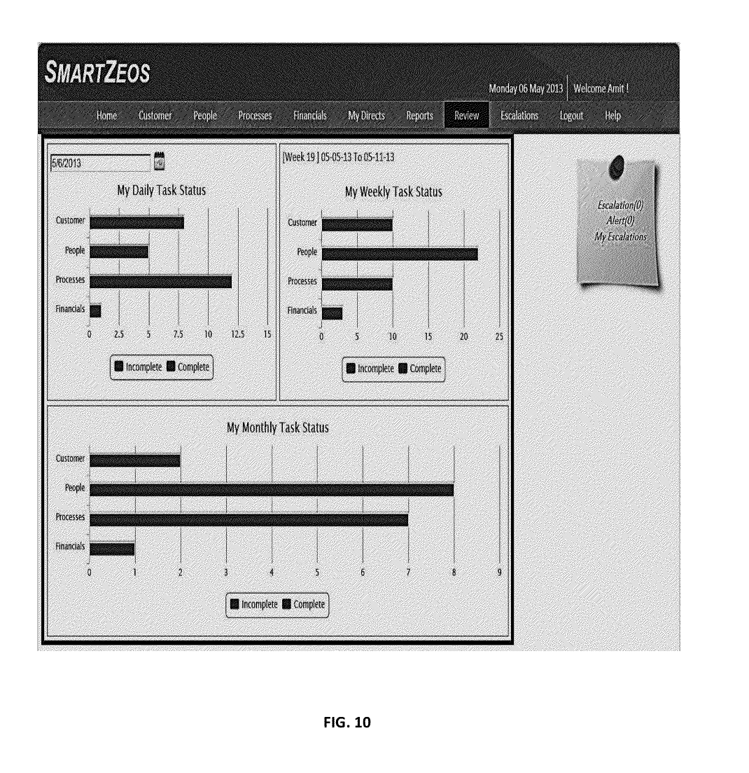

Referring to FIG. 10, there is shown an illustrative example of a reviews-focused screen. In this tab, the user may get review reports of his domain login.

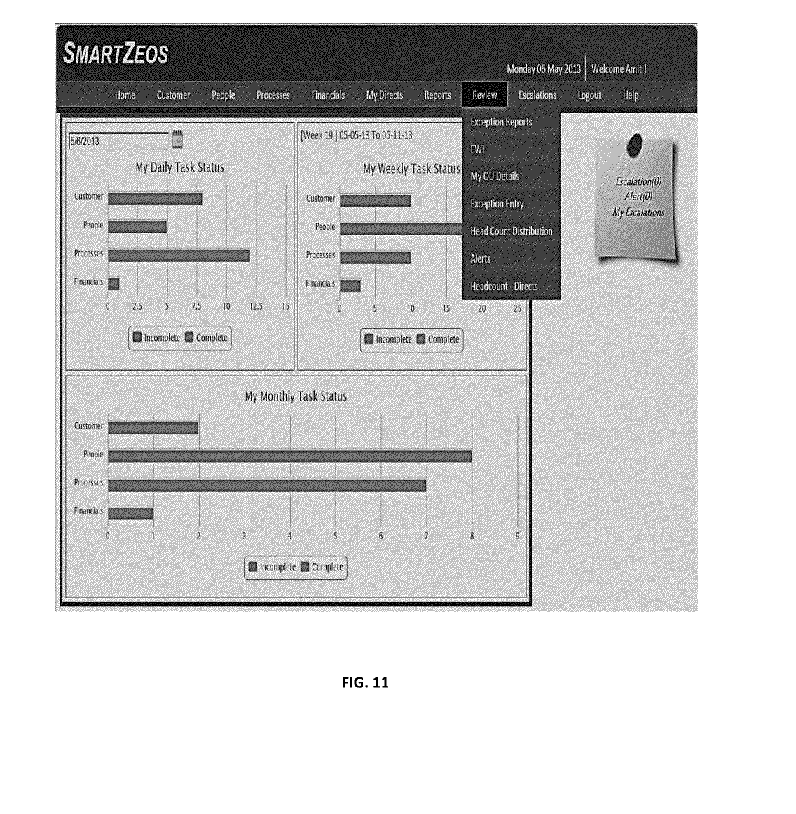

Referring to FIG. 11, there is shown an illustrative example of another reviews-focused screen. The user may view positive/negative reports, exception reports, head count distributions, alerts, headcount directs, My OU details, early warning indicators (EWI), and/or exception entry reports on this tab.

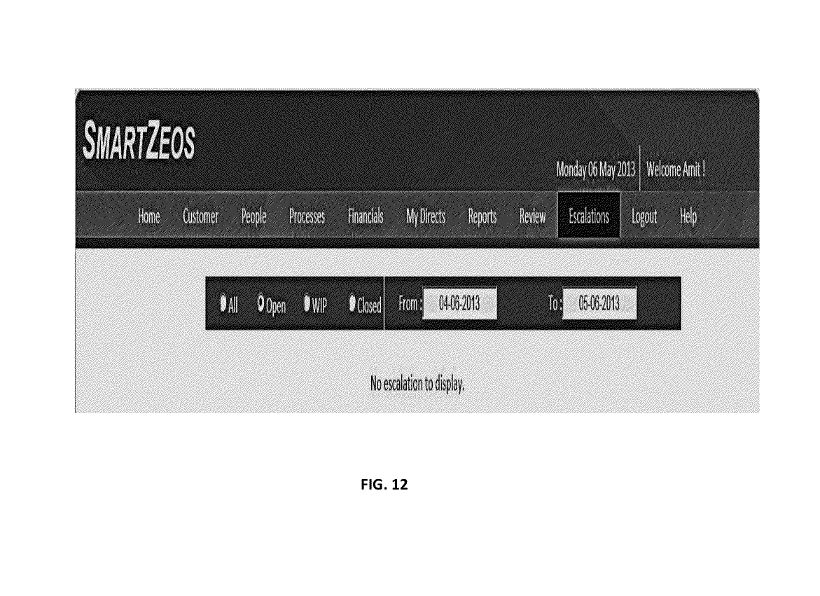

Referring to FIG. 12, there is shown an illustrative example of an escalations-focused screen. The user may view escalation all, open, work in progress (WIP) and closed, as per the calendar.

Referring to FIG. 13, there is shown an illustrative example of a help-focused screen. The user may view a help instruction page (e.g., a PDF), a “what's new has been added” page, and may also give feedback on these topics.

The present invention will deliver a significant increase in the top line and bottom line of the company implementing same. In addition to improvements in quality and customer satisfaction, there are numerous other advantages of implementing the present invention, such as, but not limited to: (1) effectiveness as a personal assistant in ensuring all daily work activities gets done without any misses; (2) gives a sense of accomplishment when the day is over; (3) tasks can be recorded quickly; (4) will create alignment, effective collaboration and segregation of duties between layers; (5) e-mail traffic can be reduced; (6) streamlining interviews using the present invention activities as a base; and/or (7) managers will be happy that the structure takes care of delegation and segregation of duties of different activities at different levels.

Balanced Scorecard:

The balanced scorecard approach of the present invention suggests that organizations be viewed from four perspectives: financials; processes; people; and customers, with equal focus and attention. The financials perspective includes traditional financial data. The processes perspective relates to internal business processes and allows a manager to determine how well a business is running and whether its products and services conform to customer requirements. The people (i.e., employee) perspective relates to employee training and corporate cultural attitudes related to both individual and corporate self-improvement. The customers perspective relates to customer focus and customer satisfaction in any business. This approach is further broken down to create KRA and KPI.

Routines:

The overall routine is a collection of tasks to achieve a goal. The entire collective of the routines achieve the organizations mission.

Tasks:

Tasks are logical and manageable components of routines that as a collective accomplish the intent of the routine.

Client Server Architecture:

Client server architecture of a computer network in which many clients (e.g., remote processors) request and receive service from a centralized server (e.g., a host computer) may be provided. Client computers may provide an interface to allow a computer user to request services of the server and to display the results the server returns. Servers may wait for requests to arrive from clients and then respond to them. Ideally, a server may provide a standardized transparent interface to clients so that clients need not be aware of the specifics of the system (i.e., the hardware and software) that is providing the service. Today, clients are often situated at workstations or on personal computers, while servers are located elsewhere on the network, usually on more powerful machines. This computing model is especially effective when clients and the server each have distinct tasks that they routinely perform. In hospital data processing, for example, a client computer can be running an application program for entering patient information while the server computer is running another program that manages the database in which the information is permanently stored. Many clients may access the server's information simultaneously, and, at the same time, a client computer may perform other tasks, such as sending e-mail. Because both client and server computers are considered intelligent devices, the client-server model is completely different from the old “mainframe” model, which utilized a centralized mainframe computer that performed all the tasks for its associated “dumb” terminals.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A computer based organizational task management system, comprising:
a computer processor unit;
a display device operably associated with the computer processor unit; and
a computer readable medium operably associated with the computer processor unit, the computer readable medium storing instructions executable by the computer processor unit to perform the steps of:
providing a balance scorecard framework;
wherein the balance scorecard framework includes at least one routine, at least one task and a central hub.

2. The invention as recited in claim 1, wherein the balanced scorecard framework includes one or more categories selected from the group consisting of financials, processes, employees and customers, wherein the financials category includes financial data, wherein the processes category includes internal business processes and allows a manager to determine how well a business is running and whether its products and services conform to customer requirements, wherein the employees category includes employee training and corporate cultural attitudes related to both individual and corporate self-improvement, wherein the customers category includes customer focus and customer satisfaction in any business, wherein the balanced scorecard framework includes the creation of key responsibility areas and key performance indicators.

3. The invention as recited in claim 2, wherein the system includes a collection of tasks to achieve a goal.

4. The invention as recited in claim 3, wherein tasks are components of routines that as a collective accomplish an intent of the routine.

5. The invention as recited in claim 4, wherein a routine and task structure is derived based on existing best practices of the day to day tasks combined with the organizational vision in terms of key responsibility areas and key performance indicators of individuals.

6. The invention as recited in claim 5, further comprising a client server architecture of a computer network in which many clients request and receive service from a centralized server, wherein the client computers provide an interface to allow a computer user to request services of the server and to display the results the server returns, wherein the servers wait for requests to arrive from clients and then respond to them, wherein a server provides a standardized interface to clients.

7. The invention as recited in claim 6, wherein the tasks are cascading and result in a collaboration between different management layers in the organization.

8. The invention as recited in claim 1, wherein the central hub permits routines and tasks to be linked to external enterprise systems.
